(19) United States
(12) Patent Application Publication
(10) Pub. No.: US 2004/0034694 A1
(43) Pub. Date: Feb. 19, 2004

(54) System, method, and computer program product in a data processing system for blocking unwanted email messages

(75) Inventors: Joe Nathan Brown, Austin, TX (US); Corradino D. Jones, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 10/219,629

(22) Filed: Aug. 15, 2002

(51) Int. Cl. G06F 15/16

(52) U.S. Cl. 709/207

(57) ABSTRACT

A system, method, and computer program product are disclosed for blocking unwanted email messages. A passcode is specified. An email message addressed to a recipient is then received within an email server. Prior to the recipient's client email application downloading the email message into the client email application, a determination is made regarding whether the passcode is included in the email message. The email message is then downloaded into the client email application only in response to a determination that the passcode is included in the email message.

### BACKGROUND OF THE INVENTION

1. Technical Field

The present invention relates generally to the field of data processing systems and, more specifically to a system, method, and computer program product in a data processing system for blocking unwanted email messages.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, such as the Internal Revenue Service and secretaries of state, which must interact with virtually all segments of society. Providing informational guides and/or searchable databases of online public records may reduce operating costs.

With the advent of the Internet, the number of electronic communications has increased sharply. It is very easy using the Internet to communicate with another user via e-mail. This ease-of-use has led to a situation where users are now bombarded with unwanted communications, such as unsolicited emails. These unsolicited emails are often referred to as “SPAM”.

One known method for blocking unsolicited email is to block all email from a particular sender's email address. Although this is effective for blocking email for that one address, senders of unsolicited email have devised a method which changes the sender's email address with each new email message. Therefore, after a user blocks a particular sender's email, that sender may transmit new email messages using a new sender address.

Therefore, a need exists for a method, system, and computer program product for blocking unwanted email messages.

### SUMMARY OF THE INVENTION

A system, method, and computer program product are disclosed for blocking unwanted email messages. A passcode is specified. An email message addressed to a recipient is then received within an email server. Prior to the recipient's client email application downloading the email message into the client email application, a determination is made regarding whether the passcode is included in the email message. The email message is then downloaded into the client email application only in response to a determination that the passcode is included in the email message.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a data processing system in accordance with the present invention;

FIG. 2 illustrates a block diagram of a computer system which may be utilized as a server computer system in accordance with the present invention;

FIG. 3 depicts a block diagram of a computer system which may be utilized as a client computer system in accordance with the present invention;

FIG. 4 is a pictorial representation of an electronic address book including passcodes in accordance with the present invention;

FIG. 5 is a pictorial representation of an email message that includes a passcode directive in the body of the email in accordance with the present invention;

FIG. 6 is a pictorial representation of an email message transmitted to two recipients that includes a passcode directive in the first line of the body of the email where the directive includes a passcode for a first recipient and a temporary passcode for a second recipient in accordance with the present invention;

FIG. 7 is a pictorial representation of an email message 700 that includes a passcode directive 702 in the first line of the body of the email where the directive includes a passcode for the recipient and an update to the sender's passcode in accordance with the present invention;

FIG. 8 depicts a high level flow chart which illustrates a sender transmitting an email message to a recipient that includes the recipient's passcode in a passcode directive in the body of the email in accordance with the present invention;

FIG. 9 illustrates a high level flow chart which depicts a recipient receiving an email message that includes a passcode directive in the body of the email message in accordance with the present invention; and

FIG. 10 depicts a high level flow chart which illustrates a user updating the user's electronic address book with a new or changed passcode and transmitting the new or changed passcode to recipients in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a system, method, and computer program product for blocking unwanted email messages. A user may specify a passcode, and then provide that passcode to entities which might send email messages to the user. When the user receives an email message, if the message includes the passcode, the entire email message may be downloaded into the user's client email application. All email that does not include the password is assumed by the client email application to be unwanted email.

According to the present invention, a passcode directive may be included as the first line in the body of an email message. The passcode directive is inserted into the email message by the sender's client email application. The email message is then transmitted to an email server. The recipient's client email application will then check the server to determine if any new email messages have been received addressed to the recipient. If a new email message has been received, the client email application will download only the header and the first line of the body of the email message.

For example, using the POP3 protocol to retrieve a user's email from a server, the “Top” primitive may be used to return only the header and a specified amount of the body of an email. In this example, the specified amount is only the first line of the body of the email.

If the first line of the body of the email message includes a passcode directive that includes a valid passcode that the recipient's client email application recognizes as being the recipient's passcode, the client email application will then download the entire email message including the entire body of the message. Before the entire email message is downloaded, the client email application will remove the passcode directive from the body of the email.

If the first line does not include a valid passcode, the email message will be treated as unwanted email. The recipient may delete all unwanted email from the server without downloading the unwanted email. Or, the recipient could specify a folder into which unwanted email is stored.

A user may specify one or more passcodes. If the passcode directive includes any one of these passcodes, the entire email message will be downloaded. Also, the email may be treated differently depending on which passcode was included. For example, email messages that included a first passcode might be placed in a first folder, while email messages that included a second passcode might be placed in a second folder.

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

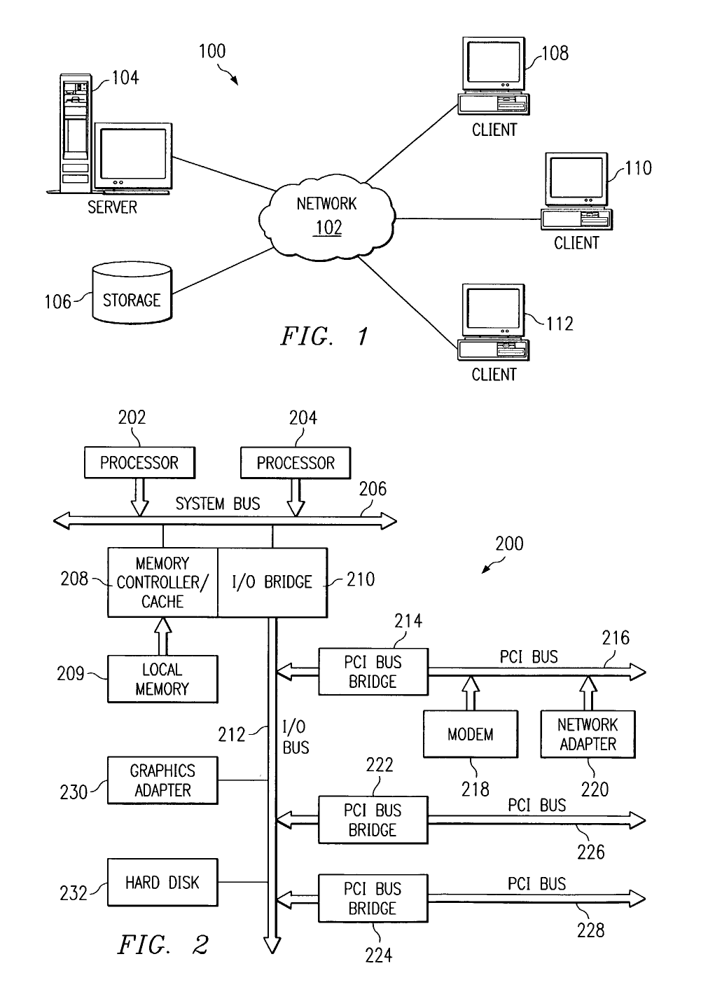

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

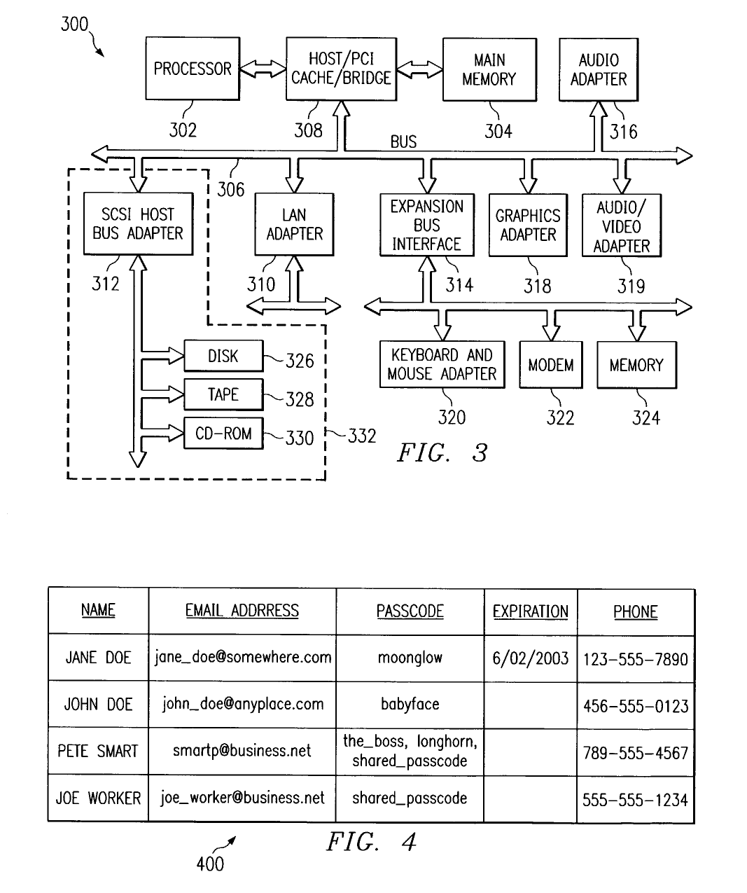

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a pictorial representation of an electronic address book 400 including passcodes in accordance with the present invention. Electronic address book 400 is stored within a user's client email application. A passcode is included for each potential recipient. Some recipients may have multiple passcodes. For example, an email message may be sent to Pete Smart using the “the_boss”, “longhorn”, or “shared passcode” passcodes. Pete Smart's client email application will retrieve the entire body of the email message when any of these passcodes is included in the passcode directive of an email message transmitted to Pete Smart.

A passcode may be temporary. An expiration date and/or time is included for temporary passcodes. For example, a temporary passcode “moonglow” is stored for Jane Doe. This passcode expires on Jun. 2, 2003. When this passcode is transmitted, the expiration is included.

A passcode may be shared among several users. For example, Pete Smart and Joe Worker both share a passcode, “shared_passcode”. This passcode is valid for either user.

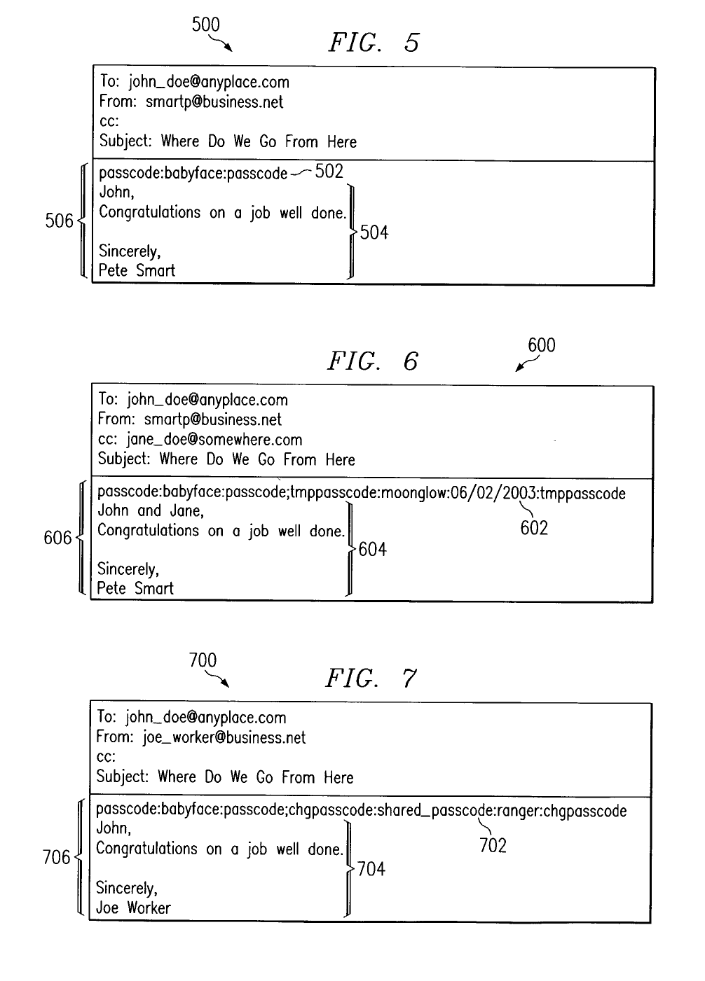

FIG. 5 is a pictorial representation of an email message 500 that includes a passcode directive 502 in the body 506 of the email 500 in accordance with the present invention. The sender “Pete Smart” prepared an email message with the contents 504 that include: “John, Congratulations on a job well done. Sincerely, Pete Smart”. When email 500 is transmitted, a passcode directive 502 is included in the body 506 of email 500. Email 500 is transmitted to an email server for John Doe. John Doe's client email application, the runs on John Doe's computer system, checks this email server for new email addressed to John Doe. When John Doe's email application checks the server, the client email application will download only the header and the passcode directive 502. Since passcode code directive 502 included John Doe's valid passcode, “babyface”, John Doe's client email application will remove passcode directive 502 and download the body of email 500 so that only contents 504 are displayed to the recipient.

Passcode directive 502 includes the passcode “babyface” for John Doe. This passcode is valid for John Doe. Therefore, when John Doe receives an email, if the email includes a passcode directive that includes the passcode “babyface”, John Doe's client email application will retrieve the entire email 500, remove passcode directive 502, and display the email 500 with contents 504 to John Doe.

FIG. 6 is a pictorial representation of an email message transmitted to two recipients that includes a passcode directive in the first line of the body of the email where the directive includes a passcode for a first recipient and a temporary passcode for a second recipient in accordance with the present invention. The sender “Pete Smart” prepared an email message with the contents 604 that include: “John and Jane, Congratulations on a job well done. Sincerely, Pete Smart”. When email 600 is transmitted, a passcode directive 602 is included in the body 606 of email 600. When email 600 is received by the intended recipients, John Doe and Jane Doe, passcode directive 602 is checked and then removed so that only contents 604 are displayed to the recipients.

Passcode directive 602 includes an example of a passcode for a first recipient and a temporary passcode for a second recipient. For example, email 600 is transmitted to two recipients, John Doe and Jane Doe. John Doe has a passcode of “babyface”. Therefore, this passcode is included in passcode directive 602. Jane Doe has a temporary passcode, “moonglow”, that expires Jun. 2, 2003. This passcode, along with its expiration date, is included in passcode directive 602.

FIG. 7 is a pictorial representation of an email message 700 that includes a passcode directive 702 in the first line of the body of the email where the directive includes a passcode for the recipient and an update to the sender's passcode in accordance with the present invention. The sender “Joe Worker” prepared an email message with the contents 704 that include: “John, Congratulations on a job well done. Sincerely, Joe Worker”. When email 700 is transmitted, a passcode directive 702 is included in the body 706 of email 700. When email 700 is received by the intended recipient, John Doe, passcode directive 702 is checked and then removed if it includes a valid passcode so that only contents 704 are displayed to the recipient.

Passcode directive 702 includes an example of a changed passcode. Passcode directive 702 includes the passcode “babyface” for the intended recipient, “John Doe”. In addition, passcode directive 702 also includes a changed passcode for the sender, “Joe Worker”. When email 700 is received by John Doe, John Doe's address book will be updated for the entry for Joe Worker to replace the passcode “shared_passcode” with the new passcode “ranger”.

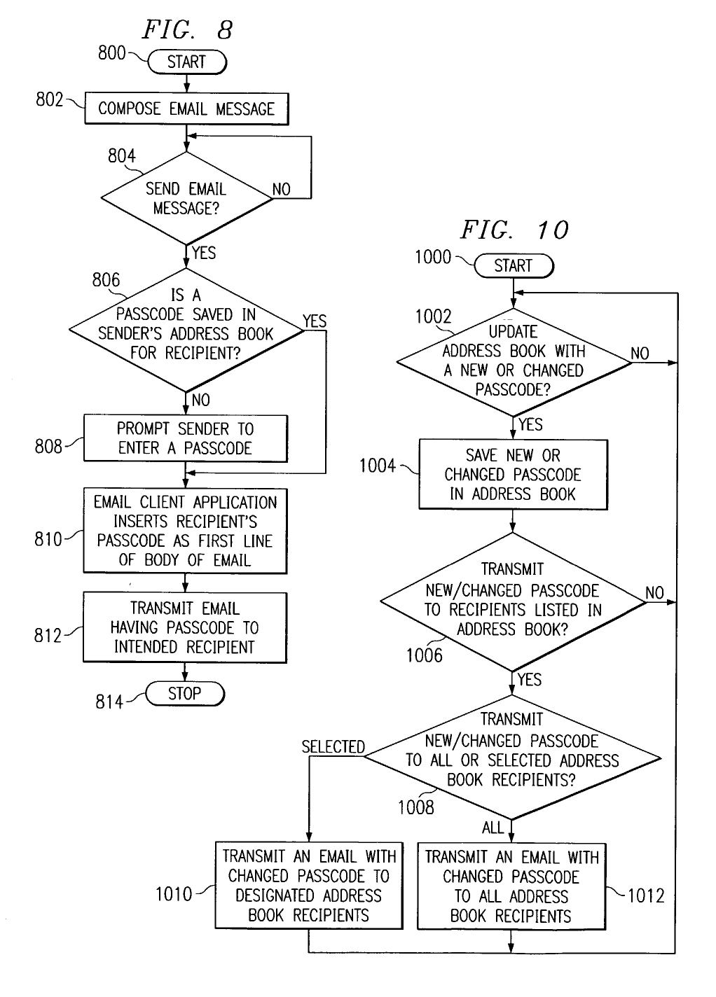

FIG. 8 depicts a high level flow chart which illustrates a sender transmitting an email message to a recipient that includes the recipient's passcode in a passcode directive in the body of the email in accordance with the present invention. The process starts as depicted by block 800 and thereafter passes to block 802 which illustrates a sender composing an email message to an intended recipient. Next, block 804 depicts a determination of whether or not the sender has selected to send the email message. If a determination is made that the sender has not selected to send the email message, the process passes back to block 804.

Referring again to block 804, if a determination is made that the sender has selected to send the email message, the process passes to block 806 which illustrates a determination by the sender's client email application of whether or not there is a passcode saved in the sender's address book for the intended recipient. If a determination is made by the client email application that there is a passcode saved in the sender's address book for the intended recipient, the process passes to block 810. Referring again to block 806, if the client email application makes a determination that there is no passcode saved in the sender's address book for the intended recipient, the process passes to block 808 which depicts the client email application prompting the sender to enter a passcode for the intended recipient. The process then passes to block 810.

Block 810 illustrates the sender's client email application inserting a passcode directive that includes the recipient's passcode as the first line in the body of the email message. Thereafter, block 812 depicts the client email application transmitting the email message including the passcode directive to the intended recipient. The process then terminates as illustrated by block 814.

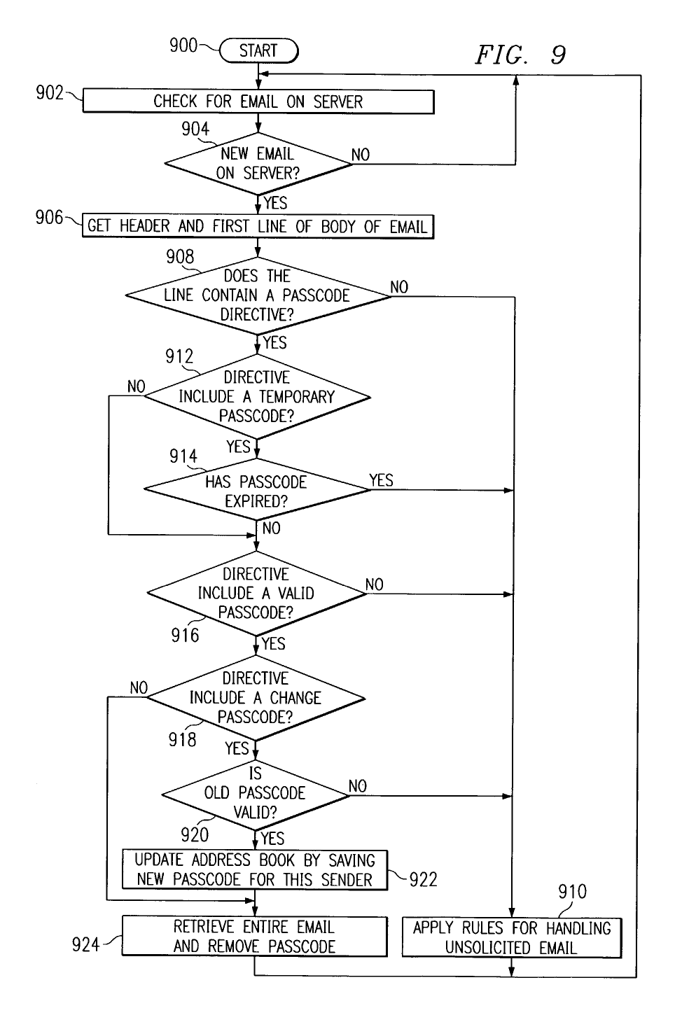

FIG. 9 illustrates a high level flow chart which depicts a recipient receiving an email message that includes a passcode directive in the body of the email message in accordance with the present invention. The process starts as depicted by block 900 and thereafter passes to block 902 which illustrates a recipient's client email application checking an email server for email transmitted to this recipient. Next, block 904 depicts a determination of whether or not new email exists for this recipient on the email server. If a determination is made that there is no new email on the email server for this recipient, the process passes back to block 902. Referring again to block 904, if a determination is made that there is new email on the email server for this recipient, the process passes to block 906 which illustrates the client email application downloading into the client email application only the header and first line of the body of the new email message.

The process passes to block 908 which depicts a determination of whether or not the first line of the body of the email message contained a passcode directive. If a determination is made that the first line of the body of the email message did not include a passcode directive, the process is passed to block 910.

Block 910 illustrates the client email application handling this email message as an unsolicited or unwanted email. When the first line does not include a valid passcode, the entire email is not retrieved. Thus, only the header and first line of the body are retrieved. The rules for handling unsolicited email are applied to this email message. For example, a recipient might designate any email message that does not include a valid passcode to be deleted automatically.

Referring again to block 908, if a determination is made that the first line of the body of the email message did include a passcode directive, the process passes to block 912 which depicts a determination of whether or not the passcode directive included a temporary passcode. If a determination is made that the passcode directive did not include a temporary passcode, the process passes to block 916.

Referring again to block 912, if a determination is made that the passcode directive did include a temporary passcode, the process passes to block 914 which illustrates a determination of whether or not the temporary passcode has expired. If a determination is made that the temporary passcode has expired, the process passes to block 910. Referring again to block 914, if a determination is made that the temporary passcode has not expired, the process passes to block 916.

Block 916 depicts a determination of whether or not the passcode directive included a valid passcode for the recipient. If a determination is made that the passcode directive did not include a valid passcode for the recipient, the process passes back to block 910. Referring again to block 916, if a determination is made that the passcode directive did include a valid passcode for the recipient, the process passes to block 918.

Block 918 depicts a determination of whether or not the first line of the body of the email includes a passcode directive that includes a change passcode to change the sender's passcode that is saved in the recipient's address book. If a determination is made that the first line of the body of the email does include a passcode directive to change the sender's passcode that is saved in the recipient's address book, the process passes to block 920 which illustrates a determination of whether or not the old passcode included in the change passcode directive is valid. If a determination is made that the old passcode included in the change passcode directive is not valid, the process passes to block 910.

Referring again to block 920, if a determination is made that the old passcode included in the change passcode directive is valid, the process passes to block 922. Block 922 illustrates the client email application updating the recipient's electronic address book by saving the new passcode that was included in the change passcode directive in the sender's entry in the recipient's address book. The process then passes to block 924 which depicts the client email application retrieving the entire email message and removing the passcode directive. The process then passes back to block 902.

Referring again to block 918, if a determination is made that the first line of the body of the email does not include a passcode directive to change the sender's passcode that is saved in the recipient's address book, the process passes to block 924 which illustrates the client email application retrieving the entire email message and removing the passcode directive. The process then passes back to block 902.

FIG. 10 depicts a high level flow chart which illustrates a user updating the user's electronic address book with a new or changed passcode and transmitting the new or changed passcode to recipients in accordance with the present invention. The process starts as depicted by block 1000 and thereafter passes to block 1002 which illustrates a determination of whether or not to update a user's electronic address book with a new or changed passcode. If a determination is made that the user's electronic address book will not be updated, the process passes back to block 1002. Referring again to block 1002, if a determination is made to update a user's electronic address book with a new or changed passcode, the process passes to block 1004 which depicts saving a new or changed passcode in the user's address book.

The process then passes to block 1006 which illustrates a determination of whether or not to transmit the new/changed passcode to the potential recipients that are listed in the user's address book. If a determination is made not to transmit the new/changed passcode to any potential recipient, the process passes back to block 1002. Referring again to block 1006, if a determination is made to transmit the new/changed passcode to potential recipients, the process passes to block 1008 which illustrates a determination of whether or not to transmit the new/changed passcode to all or only selected ones of the recipients listed in the user's electronic address book. If a determination is made to transmit the new/changed passcode to only selected recipients, the process passes to block 1010 which depicts the user's client email application transmitting an email having a passcode directive that includes the new/changed passcode to only designated address book recipients. The process then passes back to block 1002.

Referring again to block 1008, if a determination is made to transmit the new/changed passcode to all recipients listed in the user's address book, the process passes to block 1012 which depicts the user's client email application transmitting an email having a passcode directive that includes the new/changed passcode to all potential recipients that are listed in the user's electronic address book. The process then passes back to block 1002.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for blocking unwanted email messages, said method comprising the steps of:
specifying a passcode;
receiving, within an email server, an email message;
prior to a client email application downloading said email message into said client email application, determining whether said passcode is included in said email message; and
in response to a determination that said passcode is included in said email message, downloading said email message into said client email application.

2. The method according to claim 1, further comprising the step of:
in response to a determination that said passcode is not included in said email message, designating said email message as unwanted email.

3. The method according to claim 2, further comprising the steps of:
deleting all email that is designated as unwanted email without downloading any of said email that is designated as unwanted email.

4. The method according to claim 1, further comprising the steps of:
receiving said specified passcode within said client email application; and
determining, utilizing said client email application, whether said passcode is included in said email message; and
downloading, by said client email application, said email message in its entirety into said client email application.

5. The method according to claim 1, further comprising the steps of:
receiving, within a sender's client email application, a recipient's passcode;
generating, with said sender's client email application, a second email message;
inserting said passcode in said second email message prior to transmitting said second email message to said recipient; and
transmitting said second email message to said recipient.

6. The method according to claim 5, further comprising the step of inserting said passcode in a first line in a body of said second email message prior to transmitting said second email message to said recipient.

7. The method according to claim 1, further comprising the steps of:
prior to a client email application downloading said email message into said client email application, downloading only a first line of a body of said email message;
determining whether said passcode is included in said first line of said email message; and
only in response to a determination that said passcode is included in said first line of said email message, downloading an entire body of said email message into said client email application.

8. The method according to claim 1, further comprising the steps of:
prior to a client email application downloading said email message into said client email application, determining whether said passcode is included in said email message;
determining whether said passcode is a temporary passcode;
in response to a determination that said passcode is a temporary passcode, determining whether said passcode has expired;
in response to a determination that said passcode has expired, designating said email message as being unwanted email; and
in response to a determination that said passcode has not expired, downloading said email message in its entirety into said client email application.

9. A method in a data processing system for blocking unwanted email messages, said method comprising the steps of:
generating an email message;
including a passcode directive in a body of said message, said passcode directive including a passcode; and
transmitting said message including said passcode directive to a recipient, wherein said passcode is an indication to said recipient that said message is not unwanted email.

10. The method according to claim 9, further comprising the step of:
including said passcode directive in a first line of said body of said email.

11. The method according to claim 10, further comprising the steps of:
receiving said message in an email server;
downloading only a header and said passcode directive into an email client application associated with said recipient;
determining, by said email client application, whether said passcode directive includes a valid passcode for said recipient;
in response to a determination that said passcode directive includes a valid passcode for said recipient, downloading said message in its entirety; and
in response to a determination that said passcode directive does not include a valid passcode for said recipient, treating said message as unwanted email.

12. The method according to claim 10, further comprising the steps of:
transmitting said message from a sender to said recipient; and
including within said passcode directive a change passcode directive that is an indication to said recipient to change a passcode that is kept by said recipient that is associated with said sender.

13. The method according to claim 10, further comprising the step of:
including within said passcode directive a temporary passcode directive that is an indication to said recipient that said passcode is temporary.

14. A data processing system for blocking unwanted email messages, comprising:
a passcode;
an email server for receiving, within said email server, an email message;
a client computer system including a CPU for executing a client email application;
prior to said client email application downloading said email message into said client email application, said client email application determining whether said passcode is included in said email message; and
in response to a determination that said passcode is included in said email message, said client email application downloading said email message into said client email application.

15. The system according to claim 14, further comprising:
in response to a determination that said passcode is not included in said email message, said client email application designating said email message as unwanted email.

16. The system according to claim 15, further comprising:
said client email application deleting all email that is designated as unwanted email without downloading any of said email that is designated as unwanted email.

17. The system according to claim 14, further comprising:
said client email application receiving said specified passcode; and
said client email application determining whether said passcode is included in said email message; and
said client email application downloading said email message in its entirety into said client email application.

18. The system according to claim 14, further comprising:
a sender's client email application receiving a recipient's passcode;
said sender's client email application generating a second email message;
said sender's client email application inserting said passcode in said second email message prior to transmitting said second email message to said recipient; and
said sender's client email application transmitting said second email message to said recipient.

19. The system according to claim 18, further comprising said sender's client email application inserting said passcode in a first line in a body of said second email message prior to transmitting said second email message to said recipient.

20. The system according to claim 14, further comprising:
prior to a client email application downloading said email message into said client email application, said client email application downloading only a first line of a body of said email message;
said client email application determining whether said passcode is included in said first line of said email message; and
only in response to a determination that said passcode is included in said first line of said email message, said client email application downloading an entire body of said email message.

21. The system according to claim 14, further comprising:
prior to a client email application downloading said email message into said client email application, said client email application determining whether said passcode is included in said email message;
said client email application determining whether said passcode is a temporary passcode;
in response to a determination that said passcode is a temporary passcode, said client email application determining whether said passcode has expired;
in response to a determination that said passcode has expired, said client email application designating said email message as being unwanted email; and
in response to a determination that said passcode has not expired, said client email application downloading said email message in its entirety into said client email application.

22. A data processing system for blocking unwanted email messages, comprising:
an email message;
a passcode directive being included in a body of said message, said passcode directive including a passcode; and
a computer system for transmitting said message including said passcode directive to a recipient, wherein said passcode is an indication to said recipient that said message is not unwanted email.

23. The system according to claim 22, further comprising:
said passcode directive being included in a first line of said body of said email.

24. The system according to claim 23, further comprising:
said message being received in an email server;
an email client application for downloading only a header and said passcode directive into an email client application associated with said recipient;
said email client application determining whether said passcode directive includes a valid passcode for said recipient;
in response to a determination that said passcode directive includes a valid passcode for said recipient, said email client application downloading said message in its entirety; and
in response to a determination that said passcode directive does not include a valid passcode for said recipient, said email client application treating said message as unwanted email.

25. The system according to claim 23, further comprising:
said message being transmitted from a sender to said recipient; and
a change passcode directive being including within said passcode directive that is an indication to said recipient to change a passcode that is kept by said recipient that is associated with said sender.

26. The system according to claim 23, further comprising:
a temporary passcode directive being including within said passcode directive that is an indication to said recipient that said passcode is temporary.

27. A computer program product in a data processing system for blocking unwanted email messages, said product comprising:
instruction means for specifying a passcode;
instruction means for receiving, within an email server, an email message;
prior to a client email application downloading said email message into said client email application, instruction means for determining whether said passcode is included in said email message; and
in response to a determination that said passcode is included in said email message, instruction means for downloading said email message into said client email application.

28. The product according to claim 27, further comprising:
in response to a determination that said passcode is not included in said email message, instruction means for designating said email message as unwanted email.

29. The product according to claim 28, further comprising:
instruction means for deleting all email that is designated as unwanted email without downloading any of said email that is designated as unwanted email.

30. The product according to claim 27, further comprising:
instruction means for receiving said specified passcode within said client email application; and
instruction means for determining, utilizing said client email application, whether said passcode is included in said email message; and
instruction means for downloading, by said client email application, said email message in its entirety into said client email application.

31. The product according to claim 27, further comprising:
instruction means for receiving, within a sender's client email application, a recipient's passcode;
instruction means for generating, with said sender's client email application, a second email message;
instruction means for inserting said passcode in said second email message prior to transmitting said second email message to said recipient; and
instruction means for transmitting said second email message to said recipient.

32. The product according to claim 31, further comprising instruction means for inserting said passcode in a first line in a body of said second email message prior to transmitting said second email message to said recipient.

33. The product according to claim 27, further comprising:
prior to a client email application downloading said email message into said client email application, instruction means for downloading only a first line of a body of said email message;
instruction means for determining whether said passcode is included in said first line of said email message; and
only in response to a determination that said passcode is included in said first line of said email message, instruction means for downloading an entire body of said email message into said client email application.

34. The product according to claim 27, further comprising:
prior to a client email application downloading said email message into said client email application, instruction means for determining whether said passcode is included in said email message;
instruction means for determining whether said passcode is a temporary passcode;
in response to a determination that said passcode is a temporary passcode, instruction means for determining whether said passcode has expired;
in response to a determination that said passcode has expired, instruction means for designating said email message as being unwanted email; and
in response to a determination that said passcode has not expired, instruction means for downloading said email message in its entirety into said client email application.

35. A computer program product in a data processing system for blocking unwanted email messages, said product comprising:
instruction means for generating an email message;
instruction means for including a passcode directive in a body of said message, said passcode directive including a passcode; and
instruction means for transmitting said message including said passcode directive to a recipient, wherein said passcode is an indication to said recipient that said message is not unwanted email.

36. The product according to claim 35, further comprising:
instruction means for including said passcode directive in a first line of said body of said email.

37. The product according to claim 36, further comprising:
instruction means for receiving said message in an email server;
instruction means for downloading only a header and said passcode directive into an email client application associated with said recipient;
instruction means for determining, by said email client application, whether said passcode directive includes a valid passcode for said recipient;
in response to a determination that said passcode directive includes a valid passcode for said recipient, instruction means for downloading said message in its entirety; and
in response to a determination that said passcode directive does not include a valid passcode for said recipient, instruction means for treating said message as unwanted email.

38. The product according to claim 36, further comprising:
instruction means for transmitting said message from a sender to said recipient; and
instruction means for including within said passcode directive a change passcode directive that is an indication to said recipient to change a passcode that is kept by said recipient that is associated with said sender.

39. The product according to claim 36, further comprising:
instruction means for including within said passcode directive a temporary passcode directive that is an indication to said recipient that said passcode is temporary.
